(19) United States
(12) Patent Application Publication
(10) Pub. No.: US 2018/0342215 A1
(43) Pub. Date: Nov. 29, 2018

(54) LIQUID CRYSTAL DISPLAY DEVICE AND METHOD FOR DRIVING THE SAME

(71) Applicant: SHENZHEN CHINA STAR OPTOELECTRONICS TECHNOLOGY CO., LTD., Shenzhen, Guangdong (CN)

(72) Inventor: Shuai Chen, Shenzhen, Guangdong (CN)

(73) Assignee: SHENZHEN CHINA STAR OPTOELECTRONICS TECHNOLOGY CO., LTD., Shenzhen, Guangdong (CN)

(21) Appl. No.: 15/329,333

(22) PCT Filed: Jan. 13, 2017
(86) PCT No.: PCT/CN2017/071037

§ 371 Date: Dec. 7, 2017

(30) Foreign Application Priority Data
Jul. 29, 2016 (CN) 201610614119.7

(51) Int. Cl. G09G 3/36

(52) U.S. Cl. CPC G09G 3/3614; G09G 2320/0209; G09G 3/3688

(57) ABSTRACT

Disclosed are a liquid crystal display device and a method for driving the liquid crystal display device. According to the method for driving the liquid crystal display device, a liquid crystal panel in the liquid crystal display device is divided into a plurality of areas along a transverse direction. Each of the areas includes a plurality of data lines. In each of the areas, electrical potentials of m data lines are positive, and electrical potentials of n data lines are negative. When an electrical potential shift of a common electrode line is negative, m>n; and when the electrical potential shift of the common electrode line is positive, m<n.

### CROSS-REFERENCE TO RELATED APPLICATIONS

This application claims the priority of Chinese patent application CN 201610614119.7, entitled “Liquid crystal display device and method for driving the same” and filed on Jul. 29, 2016, the entirety of which is incorporated herein by reference.

### FIELD OF THE INVENTION

The present disclosure relates to the technical field of display technologies, and in particular, to a liquid crystal display device and a method for driving the liquid crystal display device.

### BACKGROUND OF THE INVENTION

With the development of display technologies, thin-film transistor liquid crystal display (TFT-LCD) screens have become the most common display devices.

Crosstalk is a common phenomenon in undesirable display effects of a liquid crystal display device. Specifically, crosstalk refers to effect of a portion of an image on other portions of the image, which causes an undesirable display effect. According to a difference in crosstalk position, crosstalk can be classified into vertical crosstalk and horizontal crosstalk.

Causes of different kinds of crosstalk are different. Generally, a difference in driving manner can cause different macroscopic manifestations of crosstalk. For example, a linear horizontal crosstalk may be caused when a frame inversion driving is used, but the horizontal crosstalk is relatively slight when a column inversion driving and a dot inversion driving are used. Whichever driving manner is used, essential causes of crosstalk are consistent, i.e., a capacitive coupling effect between data lines and a common electrode line.

For example, in a process of horizontal crosstalk generation, when electrical potentials of the data lines are changed, an instantaneous electrical potential jump is formed on the common electrode line via a parasitic capacitance C_{DC} between the data lines and the common electrode line. At this time, if signals of the common electrode line are delayed seriously or a voltage driving capability thereof is insufficient, an electrical potential of the common electrode line cannot return to a preset electrical potential. The electrical potential jump will pull down voltage differences between pixels by means of a capacitive coupling effect of a storage capacitance Cst. Thus, pixel luminance is reduced, and thereby the horizontal crosstalk is formed.

A vertical alignment (VA) display mode with a row inversion driving manner is taken as an example for illustration As shown in FIG. 1 and FIG. 2, a driving voltage of a data line Data_A is at a 128 gray-scale electrical potential all the time, and grey is displayed. A driving voltage of a data line Data_B is at the 128 gray-scale electrical potential in ⅔ of time, during which grey is displayed; and the driving voltage of the data line Data_B is at a 255 gray-scale electrical potential in ⅓ of the time, during which white is displayed. An electrical potential of the data line Data_A and an electrical potential of the data line Data_B are inverted periodically, and an electrical potential of a common electrode line COM is changed correspondingly, which causes an image to be slightly darker on the whole. However, much darker horizontal blocks may be formed in a transverse area with the 255 gray-scale electrical potential due to a bigger change in the electrical potential of the common electrode line COM, i.e., the horizontal crosstalk occurs. Generally, the horizontal crosstalk can be mitigated by using the column inversion driving and the dot inversion driving. However, a solution of changing the driving manner is easily affected by changes in a manufacturing process or other factors, so that the horizontal crosstalk cannot be effectively eliminated.

### SUMMARY OF THE INVENTION

The present disclosure aims to provide a liquid crystal display device and a method for driving the liquid crystal display device, by means of which an undesirable horizontal crosstalk can be eliminated effectively.

The present disclosure provides a method for driving the liquid crystal display device. A liquid crystal panel in the liquid crystal display device is divided into a plurality of areas along a transverse direction. Each of the areas comprises a plurality of data lines. In each of the areas, electrical potentials of m data lines are positive, and electrical potentials of n data lines are negative. When an electrical potential shift of a common electrode line is negative, m>n; and when the electrical potential shift of the common electrode line is positive, m<n.

Further, each of the areas comprises a portion with opposite polarities and a portion with a same polarity. In the portion with opposite polarities, electrical potential polarities of adjacent data lines are opposite. In the portion with a same polarity, electrical potential polarities of all data lines are same.

Preferably, data lines comprised in each of the areas are same in number.

Preferably, 4 to 12 areas are provided.

The present disclosure further provides a liquid crystal display device. The liquid crystal display device comprises a liquid crystal panel, an electrical potential detector, and a data driver. The liquid crystal panel is divided into a plurality of areas along a transverse direction, and each of the areas comprises a plurality of data lines. The electrical potential detector is used to detect an electrical potential shift amount of a common electrode line in the liquid crystal panel. The data driver is used to drive data lines in each of the areas. In each of the areas, electrical potentials of m data lines are positive, and electrical potentials of n data lines are negative. When an electrical potential shift of the common electrode line is negative, m>n; and when the electrical potential shift of the common electrode line is positive, m<n.

Further, each of the areas comprises a portion with opposite polarities and a portion with a same polarity. In the portion with opposite polarities, electrical potential polarities of adjacent data lines are opposite. In the portion with a same polarity, electrical potential polarities of all data lines are same.

Preferably, data lines comprised in each of the areas are same in number.

Preferably, 4 to 12 areas are provided.

Further, the liquid crystal panel comprises an array substrate, a color filter substrate, and a liquid crystal layer filled between the array substrate and the color filter substrate.

Preferably, the array substrate is manufactured by four times of mask patterning processes.

The present disclosure brings about the following beneficial effects. In the liquid crystal display device and the method for driving the liquid crystal display device, the liquid crystal display device is divided into a plurality of areas. Each of the areas can be driven independently. In each of the areas, the electrical potentials of m data lines are positive, and the electrical potentials of n data lines are negative. Moreover, numerical values of m and n can be adjusted according to the electrical potential shift of the common electrode line. When the electrical potential shift of the common electrode line is negative, m is adjusted to be greater than n so that data lines with positive polarities are more than data lines with negative polarities. When the electrical potential shift of the common electrode line is positive, m is adjusted to be less than n so that the data lines with negative polarities are more than the data lines with positive polarities. Besides, a difference between m and n can also be adjusted according to the electrical potential shift amount of the common electrode line. That is, a difference between data lines of two electrical potential polarities in number is adjusted so as to precisely counteract the electrical potential shift of the common electrode line. Therefore, by means of the technical solution of the present disclosure, the electrical potential shift of the common electrode line can be precisely counteracted by adjusting the data lines of the two electrical potential polarities in number, and thereby the undesirable horizontal crosstalk can be eliminated effectively.

Other features and advantages of the present disclosure will be further explained in the following description, and will partly become self-evident therefrom, or be understood through the implementation of the present disclosure. Objectives and advantages of the present disclosure will be achieved and obtained through structures specifically pointed out in the description, claims, and the accompanying drawings.

### BRIEF DESCRIPTION OF THE DRAWINGS

In order to clearly explain the technical solutions in embodiments of the present disclosure, a brief introduction is made to the accompanying drawings used in descriptions of the embodiments. In the accompanying drawings:

FIG. 1 schematically shows a horizontal crosstalk in a liquid crystal display device in the prior art;

FIG. 2 shows waveforms of electrical potentials of Data_A, and Data_B, and COM in FIG. 1;

FIG. 3 schematically shows an area of a liquid crystal panel according to a method for driving a liquid crystal display device provided in embodiment 1 of the present disclosure; and

FIG. 4 schematically shows a portion of a film layer structure of an array substrate in a liquid crystal display device provided in embodiment 2.

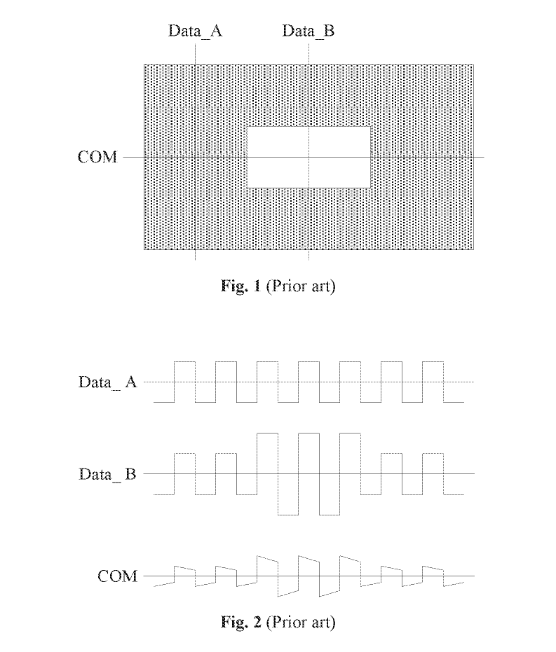

### DETAILED DESCRIPTION OF THE EMBODIMENTS

The implementation manner of the present disclosure will be explained in detail below with reference to the accompanying drawings and the embodiments, so that one can fully understand how the present disclosure solves the technical problem and achieves the technical effects through the technical means, thereby implementing the same. It should be noted that as long as there is no conflict, any of the embodiments and any of the technical features thereof may be combined with one another, and the technical solutions obtained therefrom all fall within the scope of the present disclosure.

A liquid crystal display device and a method for driving the liquid crystal display device are provided in the embodiments of the present disclosure. An electrical potential shift of a common electrode line can be precisely counteracted, and thereby an undesirable horizontal crosstalk can be effectively eliminated.

### Embodiment 1

According to a method for driving a liquid crystal display device provided in the present embodiment, a liquid crystal panel in the liquid crystal display device is divided into a plurality of areas along a transverse direction, and each of the areas comprises a plurality of data lines.

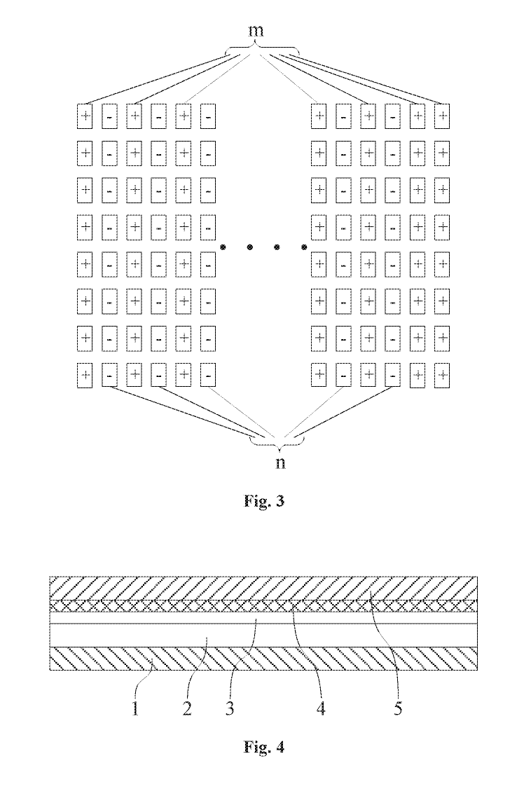

As shown in FIG. 3, in each area, data signals of m columns of sub-pixels are positive, and data signals of n columns of sub-pixels are negative. That is, electrical potentials of m data lines are positive and electrical potentials of n data lines are negative.

In the present embodiment, numerical values of m and n can be adjusted according to an electrical potential shift of a common electrode line. When the electrical potential shift of the common electrode line is negative, m is adjusted to be greater than n so that data lines with positive polarities are more than data lines with negative polarities. When the electrical potential shift of the common electrode line is positive, m is adjusted to be less than n so that the data lines with negative polarities are more than the data lines with positive polarities.

Besides, a difference between m and n can also be adjusted according to an electrical potential shift amount of the common electrode line. That is, a difference between data lines of two electrical potential polarities in number is adjusted so as to precisely counteract the electrical potential shift of the common electrode line. Therefore, by means of the technical solution provided in the present embodiment, the electrical potential shift of the common electrode line can be precisely counteracted by adjusting the data lines of the two electrical potential polarities in number, and thereby the undesirable horizontal crosstalk can be eliminated effectively.

Further, each area includes a portion with opposite polarities and a portion with a same polarity. In the portion with opposite polarities, electrical potential polarities of adjacent data lines are opposite. In the portion with a same polarity, all data lines have a same electrical potential polarity.

It can be seen from FIG. 3 that a number of the data lines with positive polarities is two more than a number of the data lines with negative polarities. That is, m−n=2. Two data lines at a rightmost side belong to the portion with a same polarity, and have positive polarities. Other data lines, excluding the two data lines at the rightmost side, belong to the portion with opposite polarities, and electrical potential polarities of any two adjacent data lines are opposite. In this way, an electrical potential polarity distribution of the data lines in the portion with opposite polarities is consistent with an electrical potential polarity distribution of the data lines in a column inversion driving manner, so that electrical potentials in an entire liquid crystal display device tend to be equalizing.

As a preferred solution, respective areas have same data lines in number, so that portions each with a same polarity in respective areas can be evenly distributed in the entire liquid crystal display device. Accordingly, an electrical potential distribution in the entire liquid crystal display device is more equalizing.

Further, a number of the areas divided should be a divisor of a total number of the data lines, and a number of the data lines comprised in each area should also be a divisor of the total number of the data lines. The number of the areas is generally arranged to be in a range from 4 to 12. For example, in a liquid crystal display device having a resolution of 3840×2160, there are 3840 columns of pixel units altogether. In the case that the liquid crystal panel is divided into 12 areas, each area includes 320 columns of pixel units. That is, 960 data lines are included.

According to the method for driving the liquid crystal display device provided by the present embodiment, the liquid crystal display panel is divided into a plurality of areas. Each area can be driven independently. In each area, electrical potentials of m data lines are positive, and electrical potentials of n data lines are negative. Moreover, the numerical values of m and n can be adjusted according to the electrical potential shift of the common electrode line. When the electrical potential shift of the common electrode line is negative, m is adjusted to be greater than n so that the data lines with positive polarities are more than the data lines with negative polarities. When the electrical potential shift of the common electrode line is positive, m is adjusted to be less than n so that the data lines with negative polarities are more than the data lines with positive polarities.

Besides, the difference between the numerical values of m and n can also be adjusted according to the electrical potential shift amount of the common electrode line. That is, the difference between the data lines of two electrical potential polarities in number is adjusted so as to precisely counteract the electrical potential shift of the common electrode line. Therefore, by means of the driving method provided in the present embodiment, the electrical potential shift of the common electrode line can be precisely counteracted by adjusting the data lines of the two electrical potential polarities in number, and thereby the undesirable horizontal crosstalk can be eliminated effectively.

### Embodiment 2

A liquid crystal display device is provided in the present embodiment. The liquid crystal display device comprises a liquid crystal panel, an electrical potential detector, and a data driver. The liquid crystal panel is divided into a plurality of areas along a transverse direction, and each of the areas comprises a plurality of data lines. The electrical potential detector is used to detect an electrical potential shift amount of a common electrode line in the liquid crystal panel.

The data driver is used to drive data lines in each area. As shown in FIG. 3, in each area, data signals of m columns of sub-pixels are positive, and data signals of n columns of sub-pixels are negative. That is, electrical potentials of m data lines are positive and electrical potentials of n data lines are negative.

In the present embodiment, numerical values of m and n can be adjusted according to an electrical potential shift of a common electrode line detected by the electrical potential detector. When the electrical potential shift of the common electrode line is negative, m is adjusted to be greater than n so that data lines with positive polarities are more than data lines with negative polarities. When the electrical potential shift of the common electrode line is positive, m is adjusted to be less than n so that the data lines with negative polarities are more than the data lines with positive polarities.

Besides, a difference between m and n can also be adjusted according to the electrical potential shift amount of the common electrode line detected by the electrical potential detector. That is, a difference between data lines of two electrical potential polarities in number is adjusted so as to precisely counteract the electrical potential shift of the common electrode line. Therefore, by means of the technical solution provided in the present embodiment, the electrical potential shift of the common electrode line can be precisely counteracted by adjusting the data lines of the two electrical potential polarities in number, and thereby the undesirable horizontal crosstalk can be eliminated effectively.

Further, each area includes a portion with opposite polarities and a portion with a same polarity. In the portion with opposite polarities, electrical potential polarities of adjacent data lines are opposite. In the portion with a same polarity, all data lines have a same electrical potential polarity.

It can be seen from FIG. 3 that a number of the data lines with positive polarities is two more than a number of the data lines with negative polarities. That is, m−n=2. Two data lines at a rightmost side belong to the portion with a same polarity, and have positive polarities. Other data lines, excluding the two data lines at the rightmost side, belong to the portion with opposite polarities, and electrical potential polarities of any two adjacent data lines are opposite. In this way, an electrical potential polarity distribution of the data lines in the portion with opposite polarities is consistent with an electrical potential polarity distribution of the data lines in a column inversion driving manner, so that electrical potentials in an entire liquid crystal display device tend to be equalizing.

As a preferred solution, respective areas have same data lines in number, so that portions each with a same polarity in respective areas can be evenly distributed in the entire liquid crystal display device. Accordingly, an electrical potential distribution in the entire liquid crystal display device is more equalizing.

Further, a number of the areas divided should be a divisor of a total number of the data lines, and a number of the data lines comprised in each area should also be a divisor of the total number of the data lines. The number of the areas is generally arranged to be in a range from 4 to 12. For example, in a liquid crystal display device having a resolution of 3840×2160, there are 3840 columns of pixel units altogether. In the case that the liquid crystal panel is divided into 12 areas, each area includes 320 columns of pixel units. That is, 960 data lines are included.

In the present embodiment, the liquid crystal panel comprises an array substrate, a color filter substrate, and a liquid crystal layer filled between the array substrate and the color filter substrate. The array substrate is manufactured by four times of mask patterning processes. A portion of a film layer structure of the array substrate is shown in FIG. 4. A first metal film 1, a SiNx layer 2, an a-Si layer 3, a semiconductor layer 4, and a second metal layer 5 are arranged sequentially from bottom to top.

Due to a special film layer structure of the array substrate manufactured by four times of mask patterning processes, degrees of the electrical potential shift of the common electrode line arranged in the first metal layer 1 are different under influence of data signals with different polarities.

When electrical potentials of data lines arranged in the second metal layer 5 are positive, free electrons generated by induction in the semiconductor 4 move towards a top of the semiconductor 4. Moreover, since the semiconductor 4 is in direct contact with the second metal layer 5, these free electrons can also enter the second metal layer 5. When electrical potentials of the data lines are negative, the free electrons generated by induction in the semiconductor 4 move towards a bottom of the semiconductor 4. Due to insulation by the SiNx layer 2 and the a-Si layer 3, these free electrons can only gather at the bottom of the semiconductor 4. Accordingly, electrical potential shifts of the common electrode line in different degrees are caused under the influence of data signals with different polarities.

In the liquid crystal display device provided in the present embodiment, the electrical potential shift of the common electrode line can be precisely counteracted by adjusting a number of data lines with different electrical potential polarities, and thereby the undesirable horizontal crosstalk can be effectively eliminated. The technical solution is especially suitable for the film layer structure of the array substrate manufactured by four times of mask patterning processes.

The technical solution provided in the present embodiment is also suitable for an array substrate manufactured by five or six times of mask patterning processes and a liquid crystal display device formed thereby.

Although embodiments of the present disclosure are provided as above, the above embodiments are described only for better understanding, rather than restricting the present disclosure. Anyone skilled in the art can make amendments to the implementing forms or details without departing from the spirit and scope of the present disclosure. The scope of the present disclosure should be subject to the scope defined in the claims.

1. A method for driving a liquid crystal display device, wherein a liquid crystal panel in the liquid crystal display device is divided into a plurality of areas along a transverse direction, each of the areas comprising a plurality of data lines,
wherein in each of the areas, electrical potentials of m data lines are positive, and electrical potentials of n data lines are negative,
wherein when an electrical potential shift of a common electrode line is negative, m>n, and
wherein when the electrical potential shift of the common electrode line is positive, m<n.

2. The method according to claim 1, wherein each of the areas comprises a portion with opposite polarities and a portion with a same polarity,
wherein in the portion with opposite polarities, electrical potential polarities of adjacent data lines are opposite, and
wherein in the portion with a same polarity, electrical potential polarities of all data lines are same.

3. The method according to claim 1, wherein data lines comprised in each of the areas are same in number.

4. The method according to claim 2, wherein 4 to 12 areas are provided.

5. A liquid crystal display device, comprising a liquid crystal panel, an electrical potential detector, and a data driver,
wherein the liquid crystal panel is divided into a plurality of areas along a transverse direction, each of the areas comprising a plurality of data lines,
wherein the electrical potential detector is used to detect an electrical potential shift amount of a common electrode line in the liquid crystal panel, and
wherein the data driver is used to drive data lines in each of the areas, wherein in each of the areas, electrical potentials of m data lines are positive, and electrical potentials of n data lines are negative, wherein when an electrical potential shift of the common electrode line is negative, m>n, and when the electrical potential shift of the common electrode line is positive, m<n.

6. The liquid crystal display device according to claim 5, wherein each of the areas comprises a portion with opposite polarities and a portion with a same polarity,
wherein in the portion with opposite polarities, electrical potential polarities of adjacent data lines are opposite, and
wherein in the portion with a same polarity, electrical potential polarities of all data lines are same.

7. The liquid crystal display device according to claim 5, wherein data lines comprised in each of the areas are same in number.

8. The liquid crystal display device according to claim 7, wherein 4 to 12 areas are provided.

9. The liquid crystal display device according to claim 5, wherein the liquid crystal panel comprises an array substrate, a color filter substrate, and a liquid crystal layer filled between the array substrate and the color filter substrate.

10. The liquid crystal display device according to claim 9, wherein the array substrate is manufactured by four times of mask patterning processes.
